(19) United States
(12) Patent Application Publication
(10) Pub. No.: US 2026/0032679 A1
(43) Pub. Date: Jan. 29, 2026

(54) PRG DITHERING FOR FREQUENCY DIVISION MULTIPLEXED PDSCH WITH DMRS SHARING

(71) Applicant: QUALCOMM Incorporated, San Diego, CA (US)

(72) Inventors: Chih-Hao LIU, San Diego, CA (US); Jing SUN, San Diego, CA (US); Somsubhra BARIK, San Diego, CA (US)

(21) Appl. No.: 18/784,760

(22) Filed: Jul. 25, 2024

(51) Int. Cl. H04W 72/1273; H04L 1/00; H04L 5/00

(52) U.S. Cl. CPC H04W 72/1273; H04L 1/0071; H04L 5/0051

(57) ABSTRACT

A method for wireless communication at a network entity and related apparatus are provided. In the method, the network entity partitions a frequency range into a set of physical resource block groups (PRGs). Each PRG of the set of PRGs includes a number of resource blocks (RBs), and the number of RBs is greater than or equal to one. The network entity further assigns the RBs in one or more PRGs of the set of PRGs respectively to multiple user equipment (UEs). The RBs corresponding to a first UE of the multiple UEs occupy varied RB indices across the one or more PRGs. The network entity further transmits, to the first UE, a downlink transmission using the RBs corresponding to the first UE.

### TECHNICAL FIELD

The present disclosure relates generally to communication systems and, more particularly, to wireless communication with frequency division multiplexed physical downlink shared channels (PDSCHs).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a user equipment (UE). The apparatus may include at least one memory and at least one processor coupled to the at least one memory. Based at least in part on information stored in the at least one memory, the at least one processor, individually or in any combination, may be configured to receive, from a network entity, a demodulation reference signal (DMRS) using a set of resource blocks (RBs), where the set of RBs occupy varied RB indices in a set of physical resource block groups (PRGs) in a frequency range, where each PRG in the set of PRGs includes a number of RBs, and the number of RBs is greater than or equal to one; estimate, based on the DMRS, channel information for a channel between the network entity and the UE; and receive a downlink transmission based on the channel information.

In an aspect of the disclosure, a method, a computer-readable medium, and an apparatus are provided for wireless communication at a network entity. The apparatus may include at least one memory and at least one processor coupled to the at least one memory. Based at least in part on information stored in the at least one memory, the at least one processor, individually or in any combination, may be configured to partition a frequency range into a set of PRGs, where each PRG of the set of PRGs includes a number of RBs, and the number of RBs is greater than or equal to one; assign the RBs in one or more PRGs of the set of PRGs respectively to multiple UEs, where the RBs corresponding to a first UE of the multiple UEs occupy varied RB indices across the one or more PRGs; and transmit, to the first UE, a downlink transmission using the RBs corresponding to the first UE.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communication system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of an interleaving process between virtual resource blocks (VRBs) and physical resource blocks (PRBs).

FIG. 5 is a diagram illustrating an example of the sharing of a common wideband demodulation reference signal (DMRS) among multiple UEs.

FIG. 6 is a diagram illustrating the examples of interleaving using an interleaver whose depth is a multiple of the PRG size.

FIG. 7 is a diagram illustrating resource blocks corresponding to one UE after an interleaving process using a coprime interleaver in accordance with various aspects of the present disclosure.

FIG. 8 is a diagram illustrating an example of using different RB cyclic shifts for different PRGs in accordance with various aspects of the present disclosure.

FIG. 9 is a diagram illustrating an example of using different RB offsets for different PDSCH symbols in accordance with various aspects of the present disclosure.

FIG. 10 is a call flow diagram illustrating a method of wireless communication in accordance with various aspects of the present disclosure.

FIG. 11 is a flowchart illustrating methods of wireless communication at a UE in accordance with various aspects of the present disclosure.

FIG. 12 is a flowchart illustrating methods of wireless communication at a network entity in accordance with various aspects of the present disclosure.

FIG. 13 is a diagram illustrating an example of a hardware implementation for an example apparatus and/or UE.

FIG. 14 is a diagram illustrating an example of a hardware implementation for an example network entity.

### DETAILED DESCRIPTION

In wireless communication, multiple user equipments (UEs) with small packets and that share the same precoding may be grouped together. Multiple physical downlink shared channels (PDSCHs) for these UEs may be frequency division multiplexed (FDMed), and these PDSCH transmissions may share a common wideband demodulation reference signal (DMRS) to achieve better channel estimation. Sub-PRG interleaving may be used so that different PDSCH transmissions may be FDMed at the sub-PRG level. However, sub-PRG interleaving with an interleaver depth that is a multiple of the PRG size may result in the division of two contiguous logical resource blocks (RBs) across two PRGs, with both occupying the same RB location in these PRGs. When PRG-based channel estimation is used, RBs at the edge of PRGs may incur larger channel estimation errors than other RBs. Hence, such a sub-PRG interleaving schemes may lead to one UE of the multiple UEs to be consistently positioned at the edge of the PRGs, and susceptible to higher estimation errors. Example aspects presented herein provide methods and apparatus for PRG dithering for FDMed PDSCHs with DMRS sharing to prevent a particular UE's allocation from always falling near the edge of the PRGs.

Various aspects relate generally to wireless communication. Some aspects more specifically relate to PRG dithering for FDMed PDSCH in wireless communication. In some examples, a network entity may partition a frequency range into a set of PRGs, and each PRG of the set of PRGs may include a number of RBs that is greater than or equal to one. The network entity further assigns the RBs in one or more PRGs of the set of PRGs respectively to multiple UEs, and the RBs corresponding to a first UE of the multiple UEs may occupy varied RB indices across the one or more PRGs. The network entity further transmits, to the first UE, a downlink transmission using the RBs corresponding to the first UE. In some examples, the network entity may assign the RBs in the one or more PRGs of the set of PRGs respectively to the multiple UEs based on an interleaver, and the width of the interleaver is coprime with the number of the RBs. In some examples, the network entity may assign the RBs in each PRG of the one or more PRGs respectively to the multiple UEs based on an interleaver and a set of index offsets for the set of PRGs. A first index offset in the set of index offsets for a first PRG of the one or more PRGs is different from a second index offset in the set of index offsets for a second PRG of the one or more PRGs.

Particular aspects of the subject matter described in this disclosure can be implemented to realize one or more of the following potential advantages. In some examples, by using interleaver depths that are coprime to the PRG size or cyclic RB shifts for the PRGs, the described techniques ensure that the RBs corresponding to individual UE are distributed more uniformly across the PRGs, thereby reducing the channel estimation errors by averaging out the errors across all RBs within the PRGs.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

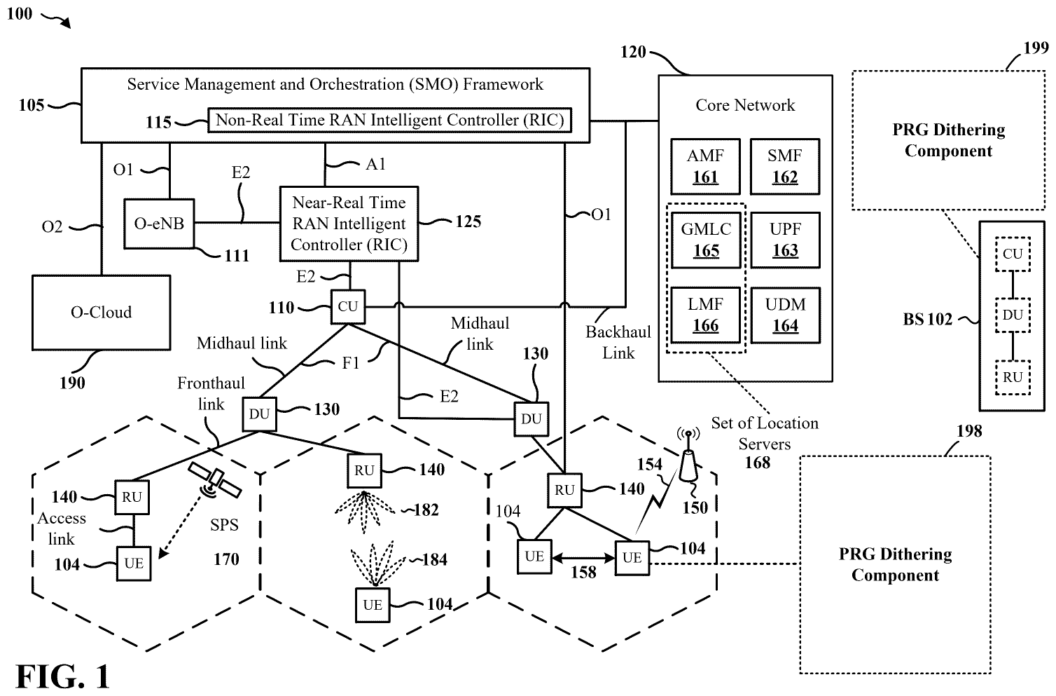

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a PRG dithering component 198. The PRG dithering component 198 may be configured to receive, from a network entity, a DMRS using a set of RBs, where the set of RBs occupy varied RB indices in a set of PRGs in a frequency range, where each PRG in the set of PRGs includes a number of RBs, and the number of RBs is greater than or equal to one; estimate, based on the DMRS, channel information for a channel between the network entity and the UE; and receive a downlink transmission based on the channel information. In certain aspects, the base station 102 may include a PRG dithering component 199. The PRG dithering component 199 may be configured to partition a frequency range into a set of PRGs, where each PRG of the set of PRGs includes a number of RBs, and the number of RBs is greater than or equal to one; assign the RBs in one or more PRGs of the set of PRGs respectively to multiple UEs, where the RBs corresponding to a first UE of the multiple UEs occupy varied RB indices across the one or more PRGs; and transmit, to the first UE, a downlink transmission using the RBs corresponding to the first UE. Although the following description may be focused on 5G NR, the concepts described herein may be applicable to other similar areas, such as LTE, LTE-A, CDMA, GSM, and other wireless technologies.

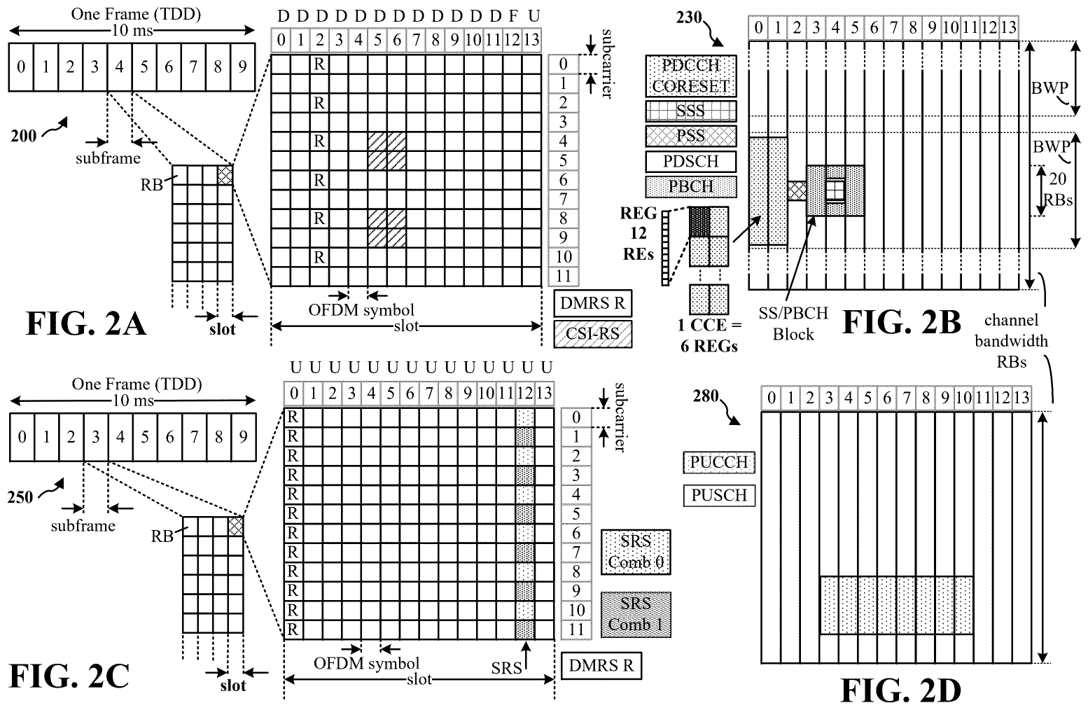

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

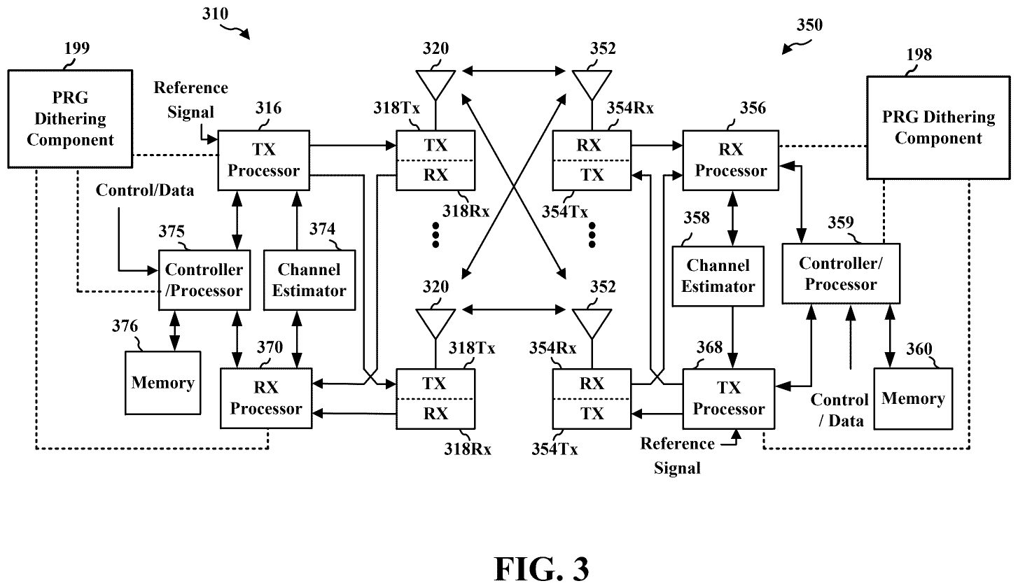

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the PRG dithering component 198 of FIG. 1.

At least one of the TX processor 316, the RX processor 370, and the controller/processor 375 may be configured to perform aspects in connection with the PRG dithering component 199 of FIG. 1.

The present disclosure provides methods and apparatus for PRG dithering for FDMed PDSCHs with DMRS sharing to prevent a particular UE's allocation from consistently falling at the edge of the PRGs and help to avoid larger channel estimation errors when PRG-based channel estimation is used for such PDSCH at the edge of the PRGs. In some examples, the PRG dithering may involve choosing an interleaver depth so that the width of the interleaver is coprime with the PRG size. In some examples, the PRG dithering may involve applying an RB cyclic shift per PRG after the interleaving.

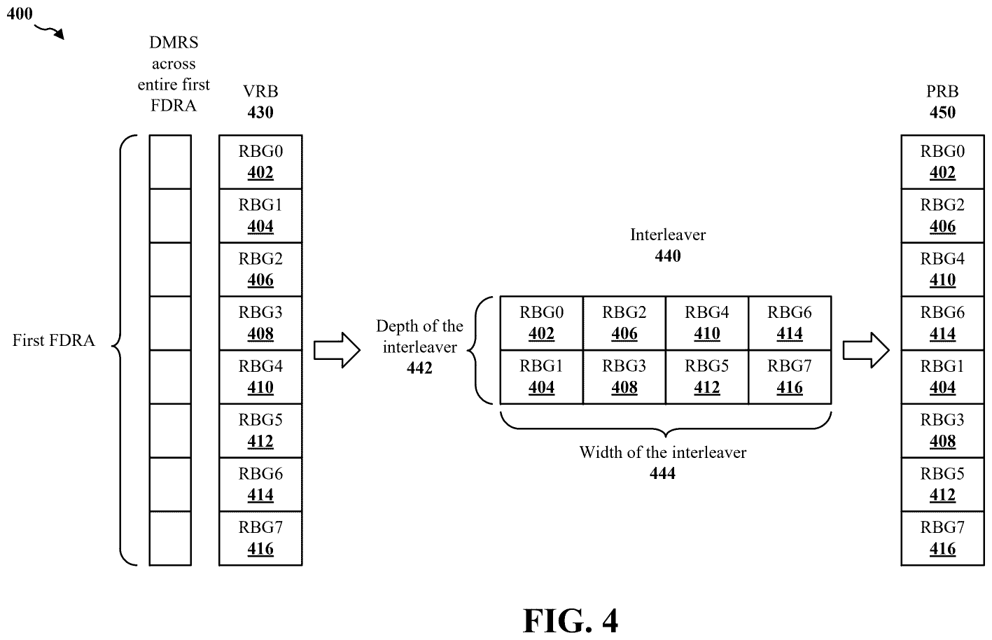

In wireless communication, an interleaver may be used for the mapping between virtual resource blocks (VRBs) and physical resource blocks (PRBs) to enhance frequency diversity within the BWP. FIG. 4 is a diagram 400 illustrating an example of an interleaving process between VRBs and PRBs. In FIG. 4, a set of VRBs 430 may include eight RBs, including RB0 402, RB1 404, RB2 406, RB3 408, RB4 410, RB5 412, RB6 414, and RB7 416, arranged sequentially. The set of VRB 430 may be mapped to a set of PRB 450 through an interleaving process. For example, as shown in FIG. 4, after applying the interleaver 440, the set of PRBs 450 may be ordered as follows: RB0 402, RB2 406, RB4 410, RB6 414, RB1 404, RB3 408, RB5 412, and RB7 416. The interleaver 440 may have a depth 442 and a width 444. For example, in FIG. 4, the depth 442 of the interleaver 440 is two, and the width 444 of the interleaver 440 is four.

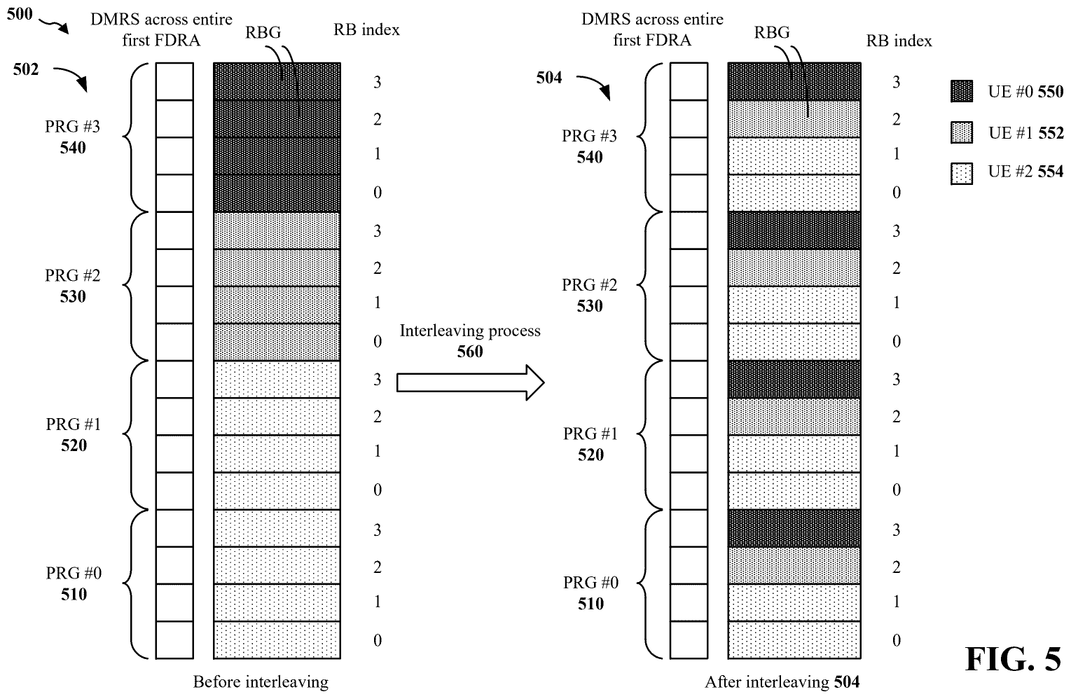

In some examples, multiple UEs with small packets and that sharing the same precoding may be grouped together to share a common wideband demodulation reference signal (DMRS) to achieve better channel estimation. For example, multiple physical downlink shared channel (PDSCH) transmissions may be frequency division multiplexed (FDMed) and share a common wideband DMRS. FIG. 5 is a diagram 500 illustrating an example of the sharing of a common wideband DMRS among multiple UEs. In FIG. 5, four PRGs, such as PRG #0 510, PRG #1 520, PRG #2 530, and PRG #3 540, may be used for the multiple UEs, such as UE0 550, UE1 552, UE2 554. Each of these four PRGs may include four RBs. In some examples, one UE may occupy a whole PRG. For example, in 502 of FIG. 5, UE #0 550 may occupy PRG #3 540, UE #1 552 may occupy PRG #2 530, and UE #2 554 may occupy PRG #2 520 and PRG #1 510.

In some examples, an interleaving process, such as those depicted in FIG. 4, may be used in a sub-PRG level so that different UEs may share a PRG and different PDSCHs may be FDMed in a sub-PRG level. For example, in 504 of FIG. 5, after the interleaving process 560, each of the four PRGs (e.g., PRG #0 510, PRG #1 520, PRG #2 530, and PRG #3 540) may include RBs for multiple UEs (e.g., UE #0 550, UE #1 552, UE #2 554).

In this scenario, the scheduling downlink control information (DCI) may have a two-part frequency domain resource allocation (FDRA). The first part of the FDRA may specify the entire frequency range occupied by all the PDSCHs (e.g., the frequency range occupied by PRG #0 510, PRG #1 520, PRG #2 53, PRG #3 540), and the second part of the FDRA may indicate the virtual resource blocks (RBs) that each UE occupies within the frequency range specified by the first part of the FDRA (e.g., the RBs occupied by UE #0 550).

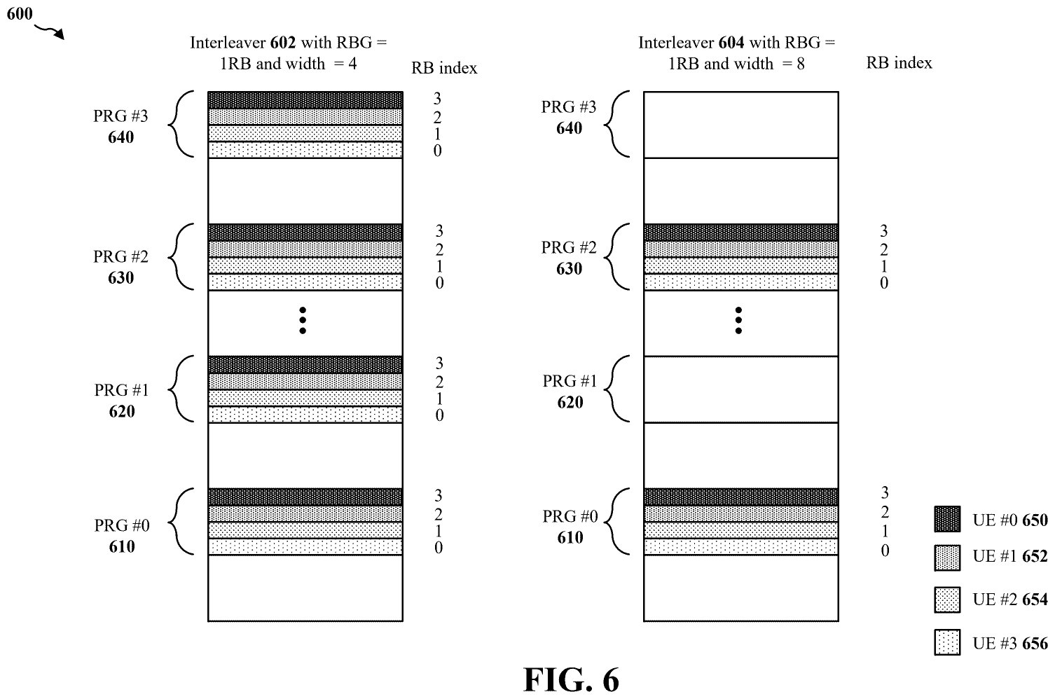

In some examples, when using an interleaver whose depth is a multiple of the PRG size (e.g., the number of RBs in the PRG) for sub-PRG interleaving, two contiguous logical resource blocks (RBs) will occupy the same RB location in two PRGs. FIG. 6 is a diagram 600 illustrating the examples of interleaving with an interleaver whose depth is a multiple of the PRG size. In FIG. 6, the PRG size is four, an interleaver 602 with a depth of four may map the logical RBs of UE #0 650 to RB of index 3 of every PRG (e.g., PRG #0 610, PRG #1 620, PRG #2 630, PRG #3 640). Similarly, the logical RBs of UE #1 652, UE #2 654, and UE #3 656 are mapped by the interleaver 602 to RB of index 2, index 1, and index 0 of every PRG, respectively. In another example, an interleaver 604 with a depth of eight may map the logical RBs of UE #0 650, UE #1 652, UE #2 654, and UE #3 656 to the RB of index 3, index 2, index 1, and index 0 of every other PRG (e.g., PRG #0 610 and PRG #2 630), respectively.

As the location for the RB corresponding to one UE is fixed in the PRG, when PRG-based channel estimation is used, RBs at the edge of PRGs may incur larger channel estimation errors than other RBs (e.g., RBs at the middle of PRGs). Hence, sub-PRG interleaving using an interleaver whose depth is a multiple of the PRG size may cause one UE of the multiple UEs to be consistently positioned at the edge of the PRGs, thus susceptible to higher estimation errors. Example aspects presented herein provide methods and apparatus for PRG dithering for FDMed PDSCHs with DMRS sharing to prevent a particular UE's allocation from repeatedly, or consistently, falling on the edge of the PRGs.

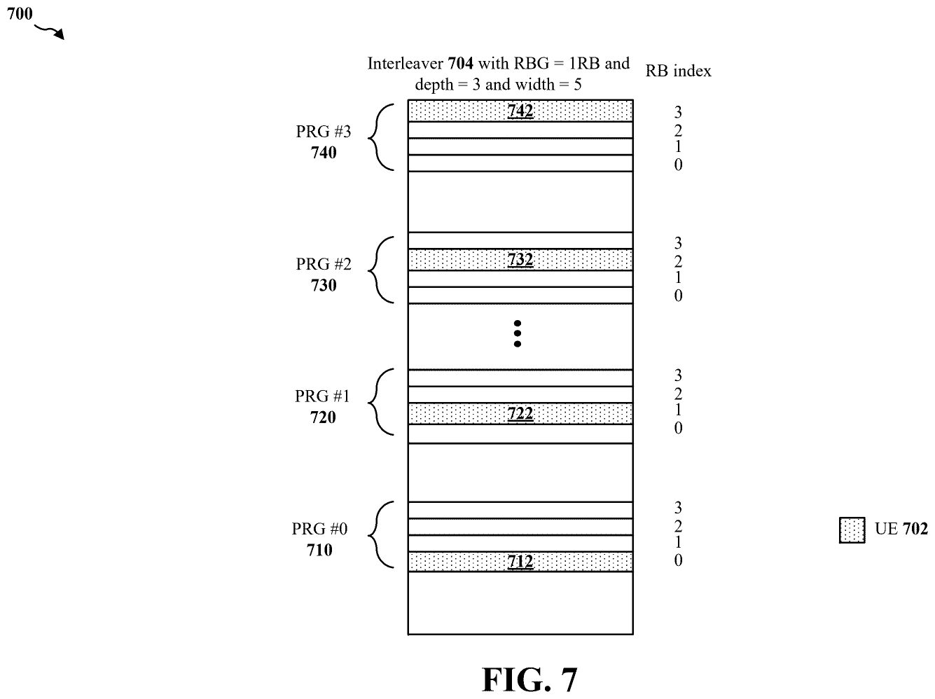

In one configuration, to prevent a UE's RBs from consistently landing on the edge of the PRGs, which leads to increased channel estimation errors, a coprime interleaver may be used in the interleaving process for FDMed PDSCH with DMRS sharing. The coprime interleave is an interleaver whose width is coprime to the PRG size, meaning the width of the interleaver and the PRG size have no common positive integer factors other than 1, or, in other words, their greatest common divisor is 1. FIG. 7 is a diagram 700 illustrating RBs corresponding to one UE after an interleaving process using a coprime interleaver in accordance with various aspects of the present disclosure. As shown in FIG. 7, for frequency division multiplexed (FDMed) PDSCH with DMRS sharing, where RB grouping (RBG) is set to one RB, the depth of the interleaver may be selected such that the width of the interleaver is coprime to the PRG size. In one configuration, the interleaver width, denoted as w, may be obtained based on the formula of:

$$w = ⌊ \frac{{N}_{R B}}{D} ⌋ \qquad ( 1 )$$

where N_{RB} is the total number of RBs and D is the depth of the interleaver, to be coprime with the PRG size.

For example, in FIG. 7, the total number is RBs is 16, and the depth of the interleaver 704 may be set at 3, so that the width of the interleaver 704 is w=5. Using the interleaver 704 in the interleaving process, the RBs for a UE (e.g., UE 702) will occupy different RB indices in different PRGs. For example, the RBs for UE 702 will occupy RB of index 0 (e.g., RB 712) for PRG #0 710, RB of index 1 (e.g., RB 722) for PRG #1 720, RB of index 2 (e.g., RB 732) for PRG #2 730, and RB of index 3 (e.g., RB 742) for PRG #3 740. In some examples, the remaining RBs, whose number is calculated as:

$${N}_{R B} - ⌊ \frac{{N}_{R B}}{D} ⌋ \cdot D ,$$

are not interleaved and may be mapped to the last few PRBs.

As shown in FIG. 7, since the RB corresponding to one UE (e.g., UE 702) occupy varied RB indices across different PRGs (e.g., RB index 0 for PRG #0 710, RB index 1 for PRG #1 720, RB index 2 for PRG #2 730, and RB index 3 for PRG #3 740), the channel estimation errors for a UE (e.g., UE 702) will be averaged across all the RBs within the PRG. In some examples, the UE may skip one or more PRGs as adjacent RBs maintain an equal distance from one another.

In one configuration, to prevent a UE's RBs from consistently landing on the edge of the PRGs, which leads to increased channel estimation errors, different RB cyclic shifts may be used for different PRGs after the interleaving process for FDMed PDSCH with DMRS sharing. As an example, a distinct RB offset ƒ(i), which may also be referred to as an index offset in some aspects, may be applied to each PRG (e.g., PRG #i) following the interleaving process, and the RB offset ƒ(i) may be defined as:

$$f ( i ) = i mod ( PRG size ) \qquad ( 2 )$$

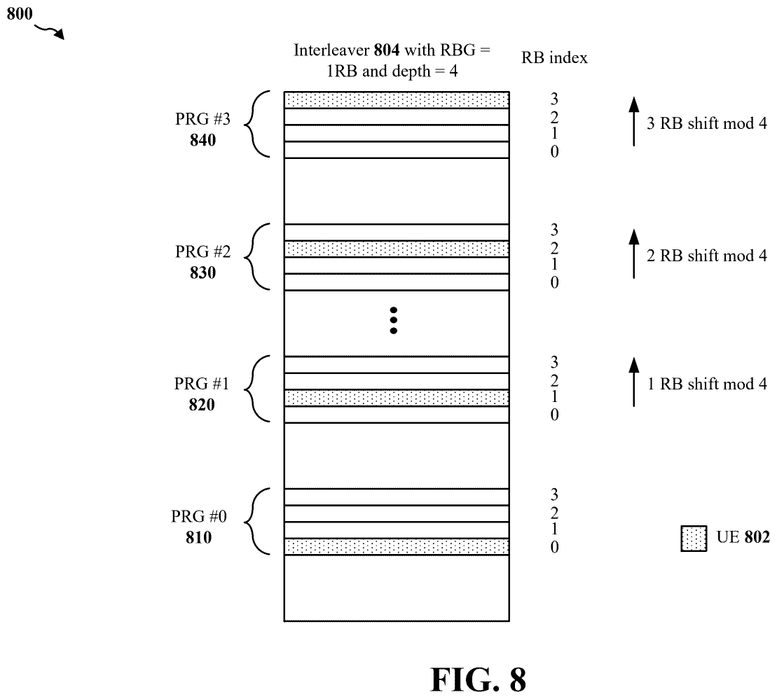

FIG. 8 is a diagram 800 illustrating an example of using different RB cyclic shifts for different PRGs in accordance with various aspects of the present disclosure. In FIG. 8, the interleaver 804 has a depth of 4, which is the same as the PRG size. Hence, after the interleaving process, the RBs corresponding to the UE 802 may be distributed in all the four PRGs (e.g., PRG #0 810, PRG #1 820, PRG #2 830, PRG #3 840). Subsequently, different RB offsets may be applied to different PRGs. As an example, the value of RB offset may be determined by Equation (2). For example, an RB offset of 1 may be applied to PRG #1 820, resulting UE 802 occupying the RB of index 1. Similarly, an RB offset of 2 may be applied to PRG #2 830, resulting UE 802 occupying the RB of index 2, and an RB offset of 3 may be applied to PRG #3 840, resulting UE 802 occupying the RB of index 3.

Using different RB offsets for different PRGs, RB corresponding to a UE may occupy varied RB index in different PRGs. Hence, the channel estimation error for the UE may be averaged across all the RBs within the PRGs. In some examples, due to different RB offsets for the PRGs, the RBs may not be equally spaced, and the network (e.g., a base station) has the flexibility in selecting the interleaver depth. In some examples, the depth of the interleaver may be selected so that the width of the interleaver is coprime to the PRG size. In some examples, the depth of the interleaver may be selected so that the width of the interleaver is not coprime to the PRG size.

In some aspects, for small frequency domain allocations, such as those involving one or two RBs, the method of dithering across PRGs to mitigate the effects on edge RBs may not feasible due to a small number of RBs (e.g., one or two RBs) in a PRG. In some aspects, the RB index may be dithered (or adjusted) on a per-symbol basis across different symbols. For example, for FDMed PDSCH with DMRS sharing, different RB cyclic shifts may be used in different PDSCH symbols within each PRG.

For example, suppose the PDSCH symbols are divided into N groups of contiguous PDSCH symbols. For each group of PDSCH symbols, denoted as n, an RB offset ƒ(n) is applied within each PRG, where the RB offset function ƒ(n) operates under modulo PRG size. For example, the RB offset may be defined by:

$$f ( n ) = n mod ( PRG size ) \qquad ( 3 )$$

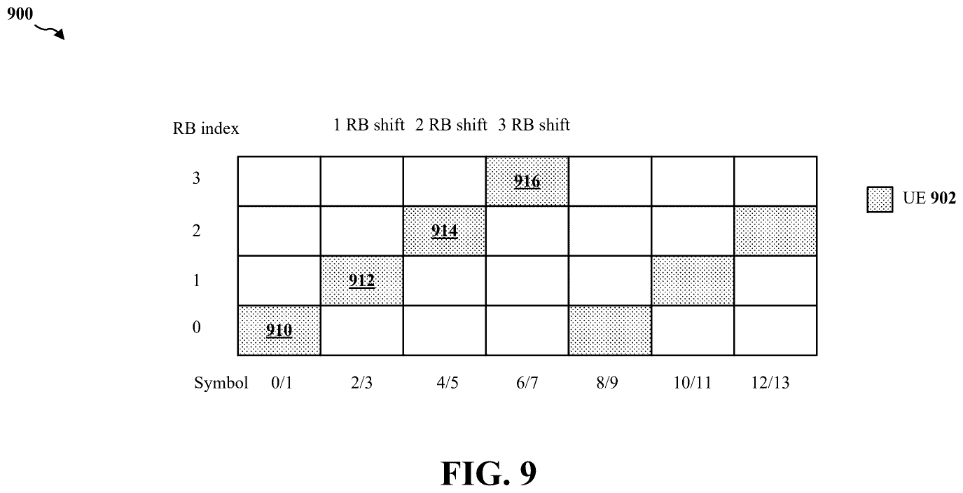

FIG. 9 is a diagram 900 illustrating an example of using different RB offset for different PDSCH symbols in accordance with various aspects of the present disclosure. In FIG. 9, each group of PDSCH symbols may include two symbols. An RB offset ƒ(n) may be applied within each PRG in these two symbols for UE 902, and the value of RB offset ƒ(n) may be determined using Equation (3). For example, based on Equation (3), no RB offset is applied to the PRG in the symbols at 910, and an RB offset of 1 is applied to each PRG in the symbols at 912. Similarly, an RB offset of 2 is applied to each PRG in the symbols at 914, and an RB offset of 3 is applied to each PRG in the symbols at 916.

Additionally, the various PRG dithering methods described above can be combined for enhanced effectiveness. For example, a coprime interleaver may be used during the interleaving process. Subsequently, a distinct RB offset, such as the RB offset determined by Equation (2), may be applied to the PRG to further distribute the RBs for a UE more uniformly across the PRGs.

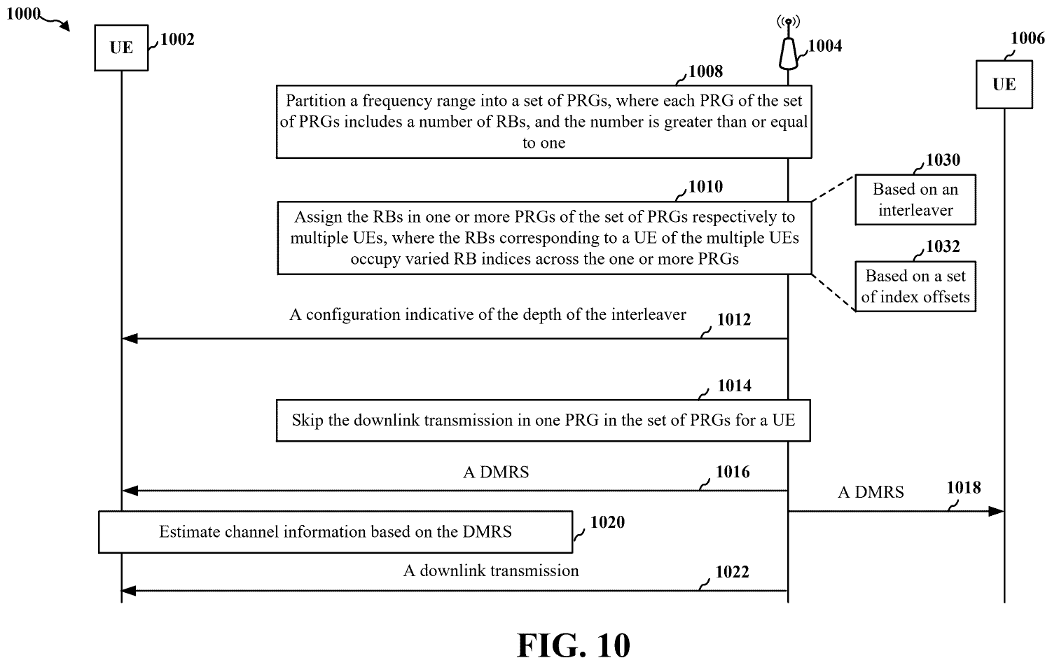

FIG. 10 is a call flow diagram 1000 illustrating a method of wireless communication in accordance with various aspects of this present disclosure. Various aspects are described in connection with a UE 1002, a UE 1006, and a base station 1004. The aspects may be performed by the UE 1002, the UE 1006 or the base station 1004 in aggregation and/or by one or more components of a base station 1004 (e.g., a CU 110, a DU 130, and/or an RU 140).

As shown in FIG. 10, at 1008, the base station 1004 may partition a frequency range into a set of PRGs. Each PRG of the set of PRGs may include a number of RBs, and the number may be greater than or equal to one. For example, referring to FIG. 7, the set of PRGs may include PRG #0 710, PRG #1 720, PRG #2 730, and PRG #3 740. Each PRG of the set of PRGs (e.g., PRG #0 710, PRG #1 720, PRG #2 730, and PRG #3 740) may include four RBs.

At 1010, the base station 1004 may assign the RBs in one or more PRGs of the set of PRGs respectively to multiple UEs including UE 1002 and UE 1006. The RBs corresponding to UE 1002 may occupy varied RB indices across the one or more PRGs. For example, in FIG. 7, the RBs for UE 702 may include RB of index 0 (e.g., RB 712) at PRG #0 710, RB of index 1 (e.g., RB 722) at PRG #1 720, RB of index 2 (e.g., RB 732) at PRG #2 730, and RB of index 3 (e.g., RB 742) at PRG #3 740. These RBs occupy different RB indices across the PRGs (e.g., PRG #0 710, PRG #1 720, PRG #2 730, and PRG #3 740).

In some examples, at 1030, the base station 1004 may assign the RBs in the one or more PRGs of the set of PRGs respectively to the multiple UEs based on an interleaver. The width of the interleaver is coprime with the number of the RBs. For example, in FIG. 7, the width of the interleaver 704 is 5, which is coprime with the number of the RBs at each PRG (i.e., 4).

In some examples, at 1032, the base station 1004 may assign the RBs in each PRG of the one or more PRGs respectively to the multiple UEs based on an interleaver and a set of index offsets for the set of PRGs. A first index offset in the set of index offsets for a first PRG of the one or more PRGs is different from a second index offset in the set of index offsets for a second PRG of the one or more PRGs. In some examples, an RB index for the UE 1002 in one PRG of the one or more PRGs is based on a modulo of the index offset for the one PRG to the number of RBs. For example, referring to FIG. 8, the index offset for PRG #1 820 is one, which is different from the index offset for PRG #2 830, which is two.

At 1012, the base station 1004 may transmit, to the UE 1002, a configuration indicative of the depth of the interleaver. The width of the interleaver (e.g., at 1030) may be based on the total number of RBs in the frequency range and the depth of the interleaver. For example, the width of the interleaver may be determined based on the total number of RBs (e.g., N_{RB}) in the frequency range and the depth of the interleaver (e.g., D) according to Equation (1).

At 1014, the base station 1004 may skip the downlink transmission in one PRG in the set of PRGs for the UE 1002.

At 1016, the base station 1004 may transmit, to the UE 1002, a DMRS using the RBs corresponding to the UE 1002. For example, in FIG. 7, the base station may transmit, to the UE 702, a DMRS using RB 712 at PRG #0 710, RB 722 at PRG #1 720, RB 732 at PRG #2 730, RB 742 at PRG #3 740.

At 1018, the base station 1004 may transmit, to the UE 1006, the DMRS using the RBs corresponding to the UE 1006. For example, in FIG. 7, the base station may transmit, to another UE, the DMRS using the RBs that are not occupied by UE 702 in the PRGs (e.g., PRG #0 710, PRG #1 720, PRG #2 730, PRG #3 740).

At 1020, the UE 1002 may estimate, based on the DMRS (received at 1016), channel information for the channel between the base station 1004 and the UE 1002.

At 1022, the base station 1004 may transmit, to the UE 1002, a downlink transmission based on the channel estimation at 1020.

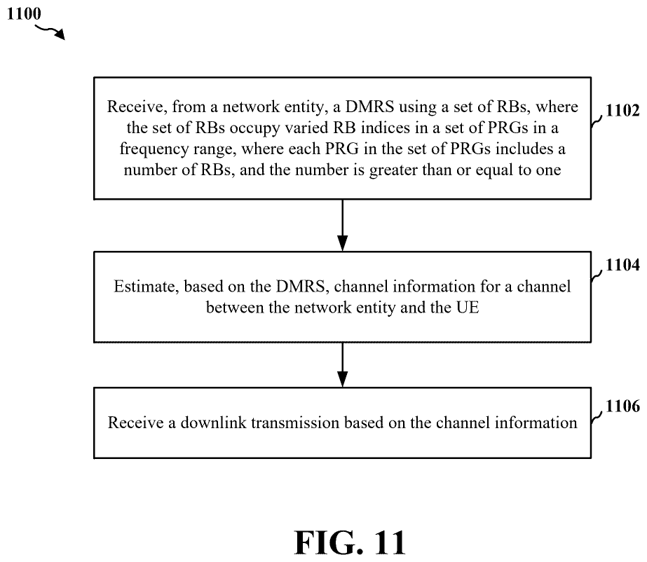

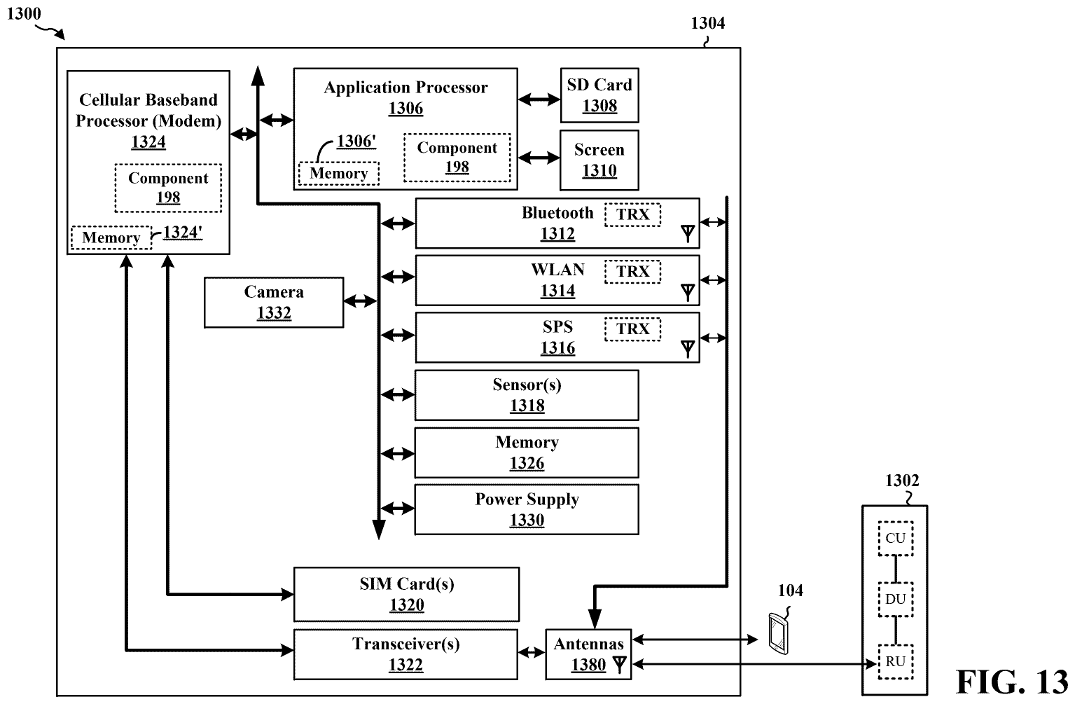

FIG. 11 is a flowchart 1100 illustrating methods of wireless communication at a UE in accordance with various aspects of the present disclosure. The method may be performed by a UE. The UE may be the UE 104, 350, 1002, or the apparatus 1304 in the hardware implementation of FIG. 13. By using interleaver depths that are coprime to the PRG size or cyclic RB shifts for the PRGs, the methods ensure that the RBs corresponding to individual UE are distributed more uniformly across the PRGs, thereby reducing the channel estimation errors by averaging out the errors across all RBs within the PRGs.

As shown in FIG. 11, at 1102, the UE may receive, from a network entity, a DMRS using a set of RBs. The set of RBs may occupy varied RB indices in a set of PRGs in a frequency range, and each PRG in the set of PRGs may include a number of RBs, and the number of RBs is greater than or equal to one. The network entity may be a base station, or a component of a base station, in the access network of FIG. 1 or a core network component (e.g., base station 102, 310, 1004; or the network entity 1302 in the hardware implementation of FIG. 13). FIG. 10 illustrates various aspects of the steps in connection with flowchart 1100. For example, referring to FIG. 10, the UE 1002 may, at 1016, receive, from a network entity (base station 1004), a DMRS using a set of RBs. In FIG. 7, the RBs that can be used for the DMRS for the UE 702 may include RB 712 at PRG #0 710, RB 722 at PRG #1 720, RB 732 at PRG #2 730, RB 742 at PRG #3 740. These RBs have varied RB indices in the set of PRGs (e.g., PRG #0 710, PRG #1 720, PRG #2 730, PRG #3 740). In some aspects, 1102 may be performed by the PRG dithering component 198.

At 1104, the UE may estimate, based on the DMRS, channel information for a channel between the network entity and the UE. For example, referring to FIG. 10, the UE 1002 may, at 1020, estimate, based on the DMRS (at 1016), channel information for a channel between the network entity (base station 1004) and the UE 1002. In some aspects, 1104 may be performed by the PRG dithering component 198.

At 1106, the UE may receive a downlink transmission based on the channel information. For example, referring to FIG. 10, the UE 1002 may, at 1022, receive a downlink transmission based on the channel information (at 1020). In some aspects, 1106 may be performed by the PRG dithering component 198.

In some aspects, the RB indices in the set of PRGs are based on an interleaver, and a width of the interleaver is coprime with the number of RBs. For example, referring to FIG. 7, the RB indices (e.g., RB indices for RB 712, 722, 732, 742) in the set of PRGs (e.g., PRG #0 710, PRG #1 720, PRG #2 730, PRG #3 740) are based on an interleaver 704, and the width of the interleaver (e.g., 5) is coprime with the number of RBs (e.g., 4).

In some aspects, the width of the interleaver is based on a total number of RBs in the frequency range and a depth of the interleaver. For example, based on Equation (1), the width of the interleaver (e.g., w) is based on a total number of RBs (e.g., N_{RB}) in the frequency range and a depth of the interleaver (e.g., D).

In some aspects, the UE may be further configured to receive, from the network entity, a configuration indicative of the depth of the interleaver. For example, referring to FIG. 10, the UE 1002 may, at 1012, receive, from the network entity (base station 1004), a configuration indicative of the depth of the interleaver.

In some aspects, the RB indices in the set of PRGs are based on a set of index offsets for the set of PRGs, and a first index offset in the set of index offsets for a first PRG of the set of PRGs is different from a second index offset in the set of index offsets for a second PRG of the set of PRGs. For example, referring to FIG. 8, the RB indices in the set of PRGs (e.g., PRG #0 810, PRG #1 820, PRG #2 830, PRG #3 840) are based on a set of index offsets for the set of PRGs. The index offset for PRG #1 820 is one, which is different from the index offset for PRG #2 830, which is two.

In some aspects, the RB index for the UE in one PRG of the set of PRG is based on a modulo of the index offset for the one PRG to the number of RBs. For example, according to Equation (2), the RB index ƒ(i) for the UE in one PRG of the set of PRG is based on a modulo of the index offset for the one PRG to the number of RBs.

In some aspects, the RB indices in the set of PRGs are based on a set of index offsets for each PRG of the set of PRGs. For one PRG of the set of PRGs, a first index offset of the set of index offsets for a first symbol for PDSCH is different from a second index offset of the set of index offsets for a second PDSCH symbol for the PDSCH. For example, referring to FIG. 9, the RB indices in the set of PRGs are based on a set of index offsets for each PRG of the set of PRGs. For one PRG of the set of PRGs, a first index offset (e.g., index offset of 0) of the set of index offsets for a first symbol (e.g., symbols at 910) for PDSCH is different from a second index offset (e.g., index offset of 1) of the set of index offsets for a second PDSCH symbol (e.g., symbols at 912) for the PDSCH.

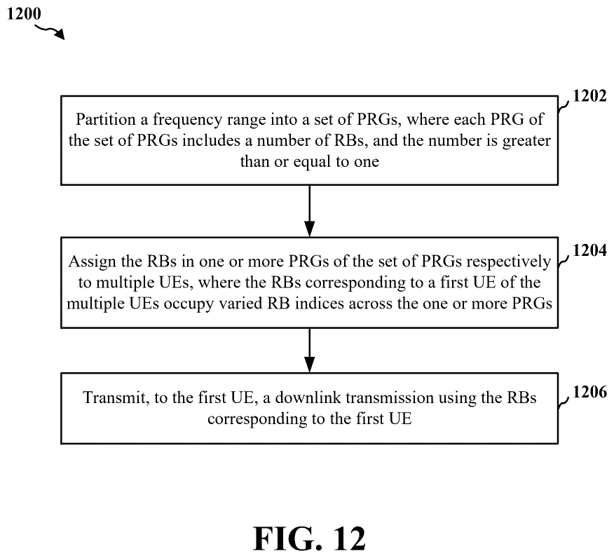

FIG. 12 is a flowchart 1200 illustrating methods of wireless communication at a network entity in accordance with various aspects of the present disclosure. The method may be performed by a network entity. The network entity may be a base station, or a component of a base station, in the access network of FIG. 1 or a core network component (e.g., base station 102, 310, 1004; or the network entity 1302 in the hardware implementation of FIG. 13). By using interleaver depths that are coprime to the PRG size or cyclic RB shifts for the PRGs, the methods ensure that the RBs corresponding to individual UE are distributed more uniformly across the PRGs, thereby reducing the channel estimation errors by averaging out the errors across all RBs within the PRGs.

As shown in FIG. 12, at 1202, the network entity may partition a frequency range into a set of PRGs. Each PRG of the set of PRGs may include a number of RBs, and the number of RBs is greater than or equal to one. FIG. 10 illustrates various aspects of the steps in connection with flowchart 1200. For example, referring to FIG. 10, the network entity (base station 1004) may, at 1008, partition a frequency range into a set of PRGs. Referring to FIG. 7, the set of PRGs may include PRG #0 710, PRG #1 720, PRG #2 730, and PRG #3 740. Each PRG of the set of PRGs (e.g., PRG #0 710, PRG #1 720, PRG #2 730, and PRG #3 740) may include four RBs. In some aspects, 1202 may be performed by the PRG dithering component 199.

At 1204, the network entity may assign the RBs in one or more PRGs of the set of PRGs respectively to multiple UEs. The RBs corresponding to a first UE of the multiple UEs may occupy varied RB indices across the one or more PRGs. The first UE may be the UE 104, 350, 1002, or the apparatus 1304 in the hardware implementation of FIG. 13. For example, referring to FIG. 10, the network entity (base station 1004) may, at 1010, assign the RBs in one or more PRGs of the set of PRGs respectively to multiple UEs. Referring to FIG. 7, the RBs for UE 702 may include RB of index 0 (e.g., RB 712) at PRG #0 710, RB of index 1 (e.g., RB 722) at PRG #1 720, RB of index 2 (e.g., RB 732) at PRG #2 730, and RB of index 3 (e.g., RB 742) at PRG #3 740. These RBs occupy different RB indices across the PRGs (e.g., PRG #0 710, PRG #1 720, PRG #2 730, and PRG #3 740). In some aspects, 1204 may be performed by the PRG dithering component 199.

At 1206, the network entity may transmit, to the first UE, a downlink transmission using the RBs corresponding to the first UE. For example, referring to FIG. 10, the network entity (base station 1004) may, at 1016 or 1022, transmit, to the first UE 1002, a downlink transmission using the RBs corresponding to the first UE 1002. In some aspects, 1206 may be performed by the PRG dithering component 199.

In some aspects, the network entity may be further configured to transmit, to the first UE, a demodulation reference signal (DMRS) using the RBs corresponding to the first UE. For example, referring to FIG. 10, the network entity (base station 1004) may, at 1016, transmit, to the first UE 1002, a DMRS using the RBs corresponding to the first UE 1002. Referring to FIG. 7, the base station may transmit, to the UE 702, a DMRS using RB 712 at PRG #0 710, RB 722 at PRG #1 720, RB 732 at PRG #2 730, and RB 742 at PRG #3 740.

In some aspects, the network entity may be further configured to transmit, to a second UE of the multiple UEs, the DMRS using the RBs corresponding to the second UE. For example, referring to FIG. 10, the network entity (base station 1004) may, at 1018, transmit, to a second UE 1006, the DMRS using the RBs corresponding to the second UE. Referring to FIG. 7, the base station may transmit, to another UE, the DMRS using the RBs that are not occupied by UE 702 in the PRGs (e.g., PRG #0 710, PRG #1 720, PRG #2 730, PRG #3 740).

In some aspects, the network entity may assign, based on an interleaver, the RBs in the one or more PRGs of the set of PRGs respectively to the multiple UEs. The width of the interleaver is coprime with the number of the RBs. For example, referring to FIG. 10, the network entity (base station 1004) may, at 1010, assign, based on an interleaver (at 1030), the RBs in the one or more PRGs of the set of PRGs respectively to the multiple UEs. The width of the interleaver is coprime with the number of the RBs. For example, referring to FIG. 7, the width of the interleaver 704 is 5, which is coprime with the number of the RBs at each PRG (i.e., 4).

In some aspects, the width of the interleaver is based on the total number of RBs in the frequency range and the depth of the interleaver. For example, based on Equation (1), the width of the interleaver (e.g., w) is based on a total number of RBs (e.g., N_{RB}) in the frequency range and a depth of the interleaver (e.g., D).

In some aspects, the network entity may be further configured to transmit, to the first UE, a configuration indicative of the depth of the interleaver. For example, referring to FIG. 10, the network entity (base station 1004) may, at 1012, transmit, to the first UE 1002, a configuration indicative of the depth of the interleaver.

In some aspects, the network entity may be further configured to skip the downlink transmission in one PRG in the set of PRGs for the first UE. For example, referring to FIG. 10, the network entity (base station 1004) may, at 1014, skip the downlink transmission in one PRG in the set of PRGs for the first UE.

In some aspects, the RBs in the one or more PRGs may each have a row location and a column location based on the interleaver, and the RB indices of the RBs corresponding to the first UE in the one or more PRGs may be based on the column locations of the RBs. For example, referring to FIG. 4, the RBs (e.g., RB 402, 404, 406, 408, etc.) in the one or more PRGs may each have a row location and a column location based on the interleaver 440, and the RB indices of the RBs corresponding to the first UE in the one or more PRGs may be based on the column locations of the RBs.

In some aspects, the network entity may be further configured to assign, based on an interleaver and a set of index offsets for the set of PRGs, the RBs in each PRG of the one or more PRGs respectively to the multiple UEs. A first index offset in the set of index offsets for a first PRG of the one or more PRGs is different from a second index offset in the set of index offsets for a second PRG of the one or more PRGs. For example, referring to FIG. 10, the network entity (base station 1004) may, at 1010, assign, based on an interleaver and a set of index offsets for the set of PRGs (at 1032), the RBs in each PRG of the one or more PRGs respectively to the multiple UEs. Referring to FIG. 8, the index offset for PRG #1 820 is one, which is different from the index offset for PRG #2 830, which is two.

In some aspects, the width of the interleaver is coprime with the number of the RBs. For example, referring to FIG. 7, the width (e.g., 5) of the interleaver 704 is coprime with the number of the RBs (e.g., 4).

In some aspects, the RB index for the first UE in one PRG of the one or more PRGs may be based on a modulo of the index offset for the one PRG to the number of RBs. For example, according to Equation (2), the RB index ƒ(i) for the UE in one PRG of the set of PRG is based on a modulo of the index offset for the one PRG to the number of RBs.

In some aspects, the network entity may be further configured to assign, based on an interleaver and a set of index offsets for each PRG of the set of PRGs, the RBs in each PRG of the one or more PRGs respectively to the multiple UEs. For one PRG of the set of PRGs, a first index offset of the set of index offsets for a first symbol for PDSCH is different from a second index offset of the set of index offsets for a second PDSCH symbol for the PDSCH. For example, referring to FIG. 9, for one PRG of the set of PRGs, a first index offset (e.g., index offset of 0) of the set of index offsets for a first symbol (e.g., symbols at 910) for PDSCH is different from a second index offset (e.g., index offset of 1) of the set of index offsets for a second PDSCH symbol (e.g., symbols at 912) for the PDSCH.

FIG. 13 is a diagram 1300 illustrating an example of a hardware implementation for an apparatus 1304. The apparatus 1304 may be a UE, a component of a UE, or may implement UE functionality. In some aspects, the apparatus 1304 may include at least one cellular baseband processor (or processing circuitry) 1324 (also referred to as a modem) coupled to one or more transceivers 1322 (e.g., cellular RF transceiver). The cellular baseband processor(s) (or processing circuitry) 1324 may include at least one on-chip memory (or memory circuitry) 1324′. In some aspects, the apparatus 1304 may further include one or more subscriber identity modules (SIM) cards 1320 and at least one application processor (or processing circuitry) 1306 coupled to a secure digital (SD) card 1308 and a screen 1310. The application processor(s) (or processing circuitry) 1306 may include on-chip memory (or memory circuitry) 1306′. In some aspects, the apparatus 1304 may further include a Bluetooth module 1312, a WLAN module 1314, an SPS module 1316 (e.g., GNSS module), one or more sensor modules 1318 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1326, a power supply 1330, and/or a camera 1332. The Bluetooth module 1312, the WLAN module 1314, and the SPS module 1316 may include an on-chip transceiver (TRX) (or in some cases, just a receiver (RX)). The Bluetooth module 1312, the WLAN module 1314, and the SPS module 1316 may include their own dedicated antennas and/or utilize the antennas 1380 for communication. The cellular baseband processor(s) (or processing circuitry) 1324 communicates through the transceiver(s) 1322 via one or more antennas 1380 with the UE 104 and/or with an RU associated with a network entity 1302. The cellular baseband processor(s) (or processing circuitry) 1324 and the application processor(s) (or processing circuitry) 1306 may each include a computer-readable medium/memory (or memory circuitry) 1324′, 1306′, respectively. The additional memory modules 1326 may also be considered a computer-readable medium/memory (or memory circuitry). Each computer-readable medium/memory (or memory circuitry) 1324′, 1306′, 1326 may be non-transitory. The cellular baseband processor(s) (or processing circuitry) 1324 and the application processor(s) (or processing circuitry) 1306 are each responsible for general processing, including the execution of software stored on the computer-readable medium/memory (or memory circuitry). The software, when executed by the cellular baseband processor(s) (or processing circuitry) 1324/application processor(s) (or processing circuitry) 1306, causes the cellular baseband processor(s) (or processing circuitry) 1324/application processor(s) (or processing circuitry) 1306 to perform the various functions described supra. The cellular baseband processor(s) (or processing circuitry) 1324 and the application processor(s) (or processing circuitry) 1306 are configured to perform the various functions described supra based at least in part of the information stored in the memory (or memory circuitry). That is, the cellular baseband processor(s) (or processing circuitry) 1324 and the application processor(s) (or processing circuitry) 1306 may be configured to perform a first subset of the various functions described supra without information stored in the memory and may be configured to perform a second subset of the various functions described supra based on the information stored in the memory. The computer-readable medium/memory (or memory circuitry) may also be used for storing data that is manipulated by the cellular baseband processor(s) (or processing circuitry) 1324/application processor(s) (or processing circuitry) 1306 when executing software. The cellular baseband processor(s) (or processing circuitry) 1324/application processor(s) (or processing circuitry) 1306 may be a component of the UE 350 and may include the at least one memory 360 and/or at least one of the TX processor 368, the RX processor 356, and the controller/processor 359. In one configuration, the apparatus 1304 may be at least one processor chip (modem and/or application) and include just the cellular baseband processor(s) (or processing circuitry) 1324 and/or the application processor(s) (or processing circuitry) 1306, and in another configuration, the apparatus 1304 may be the entire UE (e.g., see UE 350 of FIG. 3) and include the additional modules of the apparatus 1304.

As discussed supra, the component 198 may be configured to receive, from a network entity, a DMRS using a set of RBs, where the set of RBs occupy varied RB indices in a set of PRGs in a frequency range, where each PRG in the set of PRGs includes a number of RBs, and the number of RBs is greater than or equal to one; estimate, based on the DMRS, channel information for a channel between the network entity and the UE; and receive a downlink transmission based on the channel information. The component 198 may be further configured to perform any of the aspects described in connection with the flowchart in FIG. 11, and/or performed by the UE 1002 in FIG. 10. The component 198 may be within the cellular baseband processor(s) (or processing circuitry) 1324, the application processor(s) (or processing circuitry) 1306, or both the cellular baseband processor(s) (or processing circuitry) 1324 and the application processor(s) (or processing circuitry) 1306. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1304 may include a variety of components configured for various functions. In one configuration, the apparatus 1304, and in particular the cellular baseband processor(s) (or processing circuitry) 1324 and/or the application processor(s) (or processing circuitry) 1306, includes means for receiving, from a network entity, a DMRS using a set of RBs, where the set of RBs occupy varied RB indices in a set of PRGs in a frequency range, where each PRG in the set of PRGs includes a number of RBs, and the number of RBs is greater than or equal to one, means for estimating, based on the DMRS, channel information for a channel between the network entity and the UE, and means for receiving a downlink transmission based on the channel information. The apparatus 1304 may further include means for performing any of the aspects described in connection with the flowchart in FIG. 11, and/or aspects performed by the UE 1002 in FIG. 10. The means may be the component 198 of the apparatus 1304 configured to perform the functions recited by the means. As described supra, the apparatus 1304 may include the TX processor 368, the RX processor 356, and the controller/processor 359. As such, in one configuration, the means may be the TX processor 368, the RX processor 356, and/or the controller/processor 359 configured to perform the functions recited by the means.

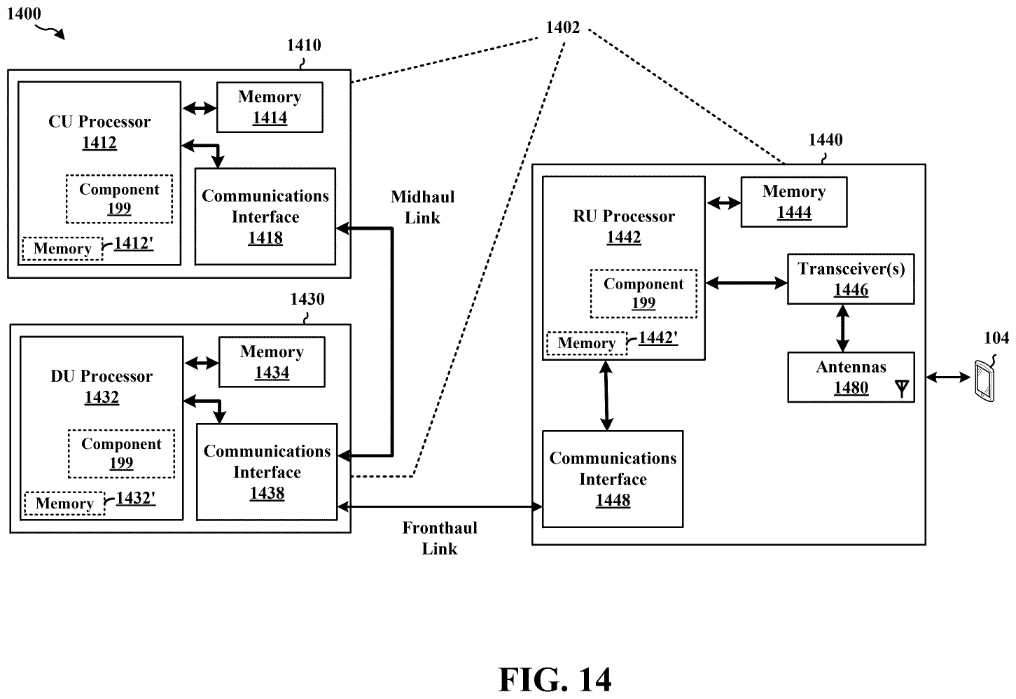

FIG. 14 is a diagram 1400 illustrating an example of a hardware implementation for a network entity 1402. The network entity 1402 may be a BS, a component of a BS, or may implement BS functionality. The network entity 1402 may include at least one of a CU 1410, a DU 1430, or an RU 1440. For example, depending on the layer functionality handled by the component 199, the network entity 1402 may include the CU 1410; both the CU 1410 and the DU 1430; each of the CU 1410, the DU 1430, and the RU 1440; the DU 1430; both the DU 1430 and the RU 1440; or the RU 1440. The CU 1410 may include at least one CU processor (or processing circuitry) 1412. The CU processor(s) (or processing circuitry) 1412 may include on-chip memory (or memory circuitry) 1412′. In some aspects, the CU 1410 may further include additional memory modules 1414 and a communications interface 1418. The CU 1410 communicates with the DU 1430 through a midhaul link, such as an F1 interface. The DU 1430 may include at least one DU processor (or processing circuitry) 1432. The DU processor(s) (or processing circuitry) 1432 may include on-chip memory (or memory circuitry) 1432′. In some aspects, the DU 1430 may further include additional memory modules 1434 and a communications interface 1438. The DU 1430 communicates with the RU 1440 through a fronthaul link. The RU 1440 may include at least one RU processor (or processing circuitry) 1442. The RU processor(s) (or processing circuitry) 1442 may include on-chip memory (or memory circuitry) 1442′. In some aspects, the RU 1440 may further include additional memory modules 1444, one or more transceivers 1446, antennas 1480, and a communications interface 1448. The RU 1440 communicates with the UE 104. The on-chip memory (or memory circuitry) 1412′, 1432′, 1442′ and the additional memory modules 1414, 1434, 1444 may each be considered a computer-readable medium/memory (or memory circuitry). Each computer-readable medium/memory (or memory circuitry) may be non-transitory. Each of the processors (or processing circuitry) 1412, 1432, 1442 is responsible for general processing, including the execution of software stored on the computer-readable medium/memory (or memory circuitry). The software, when executed by the corresponding processor(s) (or processing circuitry) causes the processor(s) (or processing circuitry) to perform the various functions described supra. The computer-readable medium/memory (or memory circuitry) may also be used for storing data that is manipulated by the processor(s) (or processing circuitry) when executing software.

As discussed supra, the component 199 may be configured to partition a frequency range into a set of PRGs, where each PRG of the set of PRGs includes a number of RBs, and the number of RBs is greater than or equal to one; assign the RBs in one or more PRGs of the set of PRGs respectively to multiple UEs, where the RBs corresponding to a first UE of the multiple UEs occupy varied RB indices across the one or more PRGs; and transmit, to the first UE, a downlink transmission using the RBs corresponding to the first UE. The component 199 may be further configured to perform any of the aspects described in connection with the flowchart in FIG. 12, and/or performed by the base station 1004 in FIG. 10. The component 199 may be within one or more processors (or processing circuitry) of one or more of the CU 1410, DU 1430, and the RU 1440. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1402 may include a variety of components configured for various functions. In one configuration, the network entity 1402 includes means for partitioning a frequency range into a set of PRGs, where each PRG of the set of PRGs includes a number of RBs, and the number of RBs is greater than or equal to one, means for assigning the RBs in one or more PRGs of the set of PRGs respectively to multiple UEs, where the RBs corresponding to a first UE of the multiple UEs occupy varied RB indices across the one or more PRGs, and means for transmitting, to the first UE, a downlink transmission using the RBs corresponding to the first UE. The network entity 1402 may further include means for performing any of the aspects described in connection with the flowchart in FIG. 12, and/or aspects performed by the base station 1004 in FIG. 10. The means may be the component 199 of the network entity 1402 configured to perform the functions recited by the means. As described supra, the network entity 1402 may include the TX processor 316, the RX processor 370, and the controller/processor 375. As such, in one configuration, the means may be the TX processor 316, the RX processor 370, and/or the controller/processor 375 configured to perform the functions recited by the means.

This disclosure provides a method for wireless communication at a network entity. The method may include partitioning a frequency range into a set of PRGs, where each PRG of the set of PRGs includes a number of RBs, and the number of RBs is greater than or equal to one; assigning the RBs in one or more PRGs of the set of PRGs respectively to multiple UEs, where the RBs corresponding to a first UE of the multiple UEs occupy varied RB indices across the one or more PRGs; and transmitting, to the first UE, a downlink transmission using the RBs corresponding to the first UE. By using interleaver depths that are coprime to the PRG size or cyclic RB shifts for the PRGs, the methods ensure that the RBs corresponding to individual UE are distributed more uniformly across the PRGs, thereby reducing the channel estimation errors by averaging out the errors across all RBs within the PRGs.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE. The method includes receiving, from a network entity, a demodulation reference signal (DMRS) using a set of resource blocks (RBs), wherein the set of RBs occupy varied RB indices in a set of physical resource block groups (PRGs) in a frequency range, wherein each PRG in the set of PRGs includes a number of RBs, and the number of RBs is greater than or equal to one; estimating, based on the DMRS, channel information for a channel between the network entity and the UE; and receiving a downlink transmission based on the channel information.

Aspect 2 is the method of aspect 1, wherein the RB indices in the set of PRGs are based on an interleaver, and a width of the interleaver is coprime with the number of RBs.

Aspect 3 is the method of aspect 2, wherein the width of the interleaver is based on a total number of RBs in the frequency range and a depth of the interleaver.

Aspect 4 is the method of aspect 3, where the method further includes receiving, from the network entity, a configuration indicative of the depth of the interleaver.

Aspect 5 is the method of any of aspects 1 to 4, wherein the RB indices in the set of PRGs are based on a set of index offsets for the set of PRGs, wherein a first index offset in the set of index offsets for a first PRG of the set of PRGs is different from a second index offset in the set of index offsets for a second PRG of the set of PRGs.

Aspect 6 is the method of aspect 5, wherein the RB index for the UE in one PRG of the set of PRG is based on a modulo of the index offset for the one PRG to the number of RBs.

Aspect 7 is the method of any of aspects 1 to 6, wherein the RB indices in the set of PRGs are based on a set of index offsets for each PRG of the set of PRGs, wherein, for one PRG of the set of PRGs, a first index offset of the set of index offsets for a first symbol for physical downlink shared channel (PDSCH) is different from a second index offset of the set of index offsets for a second PDSCH symbol for the PDSCH.

Aspect 8 is an apparatus for wireless communication at a UE, comprising: a processing system that includes processor circuitry and memory circuitry that stores code and is coupled with the processor circuitry, the processing system configured to cause the UE to perform the method of one or more of aspects 1-7.

Aspect 9 is an apparatus for wireless communication at a UE, comprising: at least one memory; and at least one processor coupled to the at least one memory and, where the at least one processor, individually or in any combination, is configured to perform the method of any of aspects 1-7.

Aspect 10 is the apparatus for wireless communication at a UE, comprising means for performing each step in the method of any of aspects 1-7.

Aspect 11 is an apparatus of any of aspects 8-10, further comprising a transceiver configured to receive or to transmit in association with the method of any of aspects 1-7.

Aspect 12 is a computer-readable medium (e.g., a non-transitory computer-readable medium) storing computer executable code at a UE, the code when executed by at least one processor causes the at least one processor to, individually or in any combination, perform the method of any of aspects 1-7.

Aspect 13 is a method of wireless communication at a network entity. The method includes partitioning a frequency range into a set of physical resource block groups (PRGs), wherein each PRG of the set of PRGs includes a number of resource blocks (RBs), and the number of RBs is greater than or equal to one; assigning the RBs in one or more PRGs of the set of PRGs respectively to multiple user equipment (UEs), wherein the RBs corresponding to a first UE of the multiple UEs occupy varied RB indices across the one or more PRGs; and transmitting, to the first UE, a downlink transmission using the RBs corresponding to the first UE.

Aspect 14 is the method of aspect 13, where the method further includes transmitting, to the first UE, a demodulation reference signal (DMRS) using the RBs corresponding to the first UE.

Aspect 15 is the method of aspect 14, where the method further includes transmitting, to a second UE of the multiple UEs, the DMRS using the RBs corresponding to the second UE.

Aspect 16 is the method of aspect 14, where assigning the RBs in the one or more PRGs of the set of PRGs respectively to the multiple UEs includes assigning, based on an interleaver, the RBs in the one or more PRGs of the set of PRGs respectively to the multiple UEs, wherein a width of the interleaver is coprime with the number of the RBs.

Aspect 17 is the method of aspect 16, wherein the width of the interleaver is based on a total number of RBs in the frequency range and a depth of the interleaver.

Aspect 18 is the method of aspect 17, where the method further includes transmitting, to the first UE, a configuration indicative of the depth of the interleaver.

Aspect 19 is the method of any of aspects 13 to 16, wherein the method further includes skipping the downlink transmission in one PRG in the set of PRGs for the first UE.

Aspect 20 is the method of any of aspects 13 to 16, wherein the RBs in the one or more PRGs each have a row location and a column location based on the interleaver, and wherein the RB indices of the RBs corresponding to the first UE in the one or more PRGs are based on the column locations of the RBs.

Aspect 21 is the method of any of aspects 14 to 20, where assigning the RBs in the one or more PRGs respectively to the multiple UEs includes assigning, based on an interleaver and a set of index offsets for the set of PRGs, the RBs in each PRG of the one or more PRGs respectively to the multiple UEs, wherein a first index offset in the set of index offsets for a first PRG of the one or more PRGs is different from a second index offset in the set of index offsets for a second PRG of the one or more PRGs.

Aspect 22 is the method of aspect 21, wherein a width of the interleaver is coprime with the number of the RBs.

Aspect 23 is the method of aspect 21, wherein an RB index for the first UE in one PRG of the one or more PRGs is based on a modulo of the index offset for the one PRG to the number of RBs.

Aspect 24 is the method of any of aspects 14 to 23, where assigning the RBs in each PRG of the one or more PRGs respectively to the multiple UEs includes assigning, based on an interleaver and a set of index offsets for each PRG of the set of PRGs, the RBs in each PRG of the one or more PRGs respectively to the multiple UEs, wherein, for one PRG of the set of PRGs, a first index offset of the set of index offsets for a first symbol for physical downlink shared channel (PDSCH) is different from a second index offset of the set of index offsets for a second PDSCH symbol for the PDSCH.

Aspect 25 is an apparatus for wireless communication at a network entity, comprising: a processing system that includes processor circuitry and memory circuitry that stores code and is coupled with the processor circuitry, the processing system configured to cause the network entity to perform the method of one or more of aspects 13-24.

Aspect 26 is an apparatus for wireless communication at a network entity, comprising: at least one memory; and at least one processor coupled to the at least one memory and, where the at least one processor, individually or in any combination, is configured to perform the method of any of aspects 13-24.

Aspect 27 is the apparatus for wireless communication at a network entity, comprising means for performing each step in the method of any of aspects 13-24.

Aspect 28 is an apparatus of any of aspects 25-27, further comprising a transceiver configured to receive or to transmit in association with the method of any of aspects 13-24.

Aspect 29 is a computer-readable medium (e.g., a non-transitory computer-readable medium) storing computer executable code at a network entity, the code when executed by at least one processor causes the at least one processor to, individually or in any combination, perform the method of any of aspects 13-24.

What is claimed is:

1. An apparatus for wireless communication at a user equipment (UE), comprising:
at least one memory; and
at least one processor coupled to the at least one memory and, based at least in part on information stored in the at least one memory, the at least one processor, individually or in any combination, is configured to cause the UE to:
receive, from a network entity, a demodulation reference signal (DMRS) using a set of resource blocks (RBs), wherein the set of RBs occupy varied RB indices in a set of physical resource block groups (PRGs) in a frequency range, wherein each PRG in the set of PRGs includes a number of RBs, and the number of RBs is greater than or equal to one;
estimate, based on the DMRS, channel information for a channel between the network entity and the UE; and
receive a downlink transmission based on the channel information.

2. The apparatus of claim 1, further comprising a transceiver coupled to the at least one processor, wherein receive the DMRS, the at least one processor, individually or in any combination, is configured to cause the UE to receive the DMRS via the transceiver, and wherein the RB indices in the set of PRGs are based on an interleaver, and a width of the interleaver is coprime with the number of RBs.

3. The apparatus of claim 2, wherein the width of the interleaver is based on a total number of RBs in the frequency range and a depth of the interleaver.

4. The apparatus of claim 3, wherein the at least one processor, individually or in any combination, is configured to cause the UE to:
receive, from the network entity, a configuration indicative of the depth of the interleaver.

5. The apparatus of claim 1, wherein the RB indices in the set of PRGs are based on a set of index offsets for the set of PRGs, wherein a first index offset in the set of index offsets for a first PRG of the set of PRGs is different from a second index offset in the set of index offsets for a second PRG of the set of PRGs.

6. The apparatus of claim 5, wherein the RB index for the UE in one PRG of the set of PRG is based on a modulo of the index offset for the one PRG to the number of RBs.

7. The apparatus of claim 1, wherein the RB indices in the set of PRGs are based on a set of index offsets for each PRG of the set of PRGs, wherein, for one PRG of the set of PRGs, a first index offset of the set of index offsets for a first symbol for physical downlink shared channel (PDSCH) is different from a second index offset of the set of index offsets for a second PDSCH symbol for the PDSCH.

8. An apparatus for wireless communication at a network entity, comprising:
at least one memory; and
at least one processor coupled to the at least one memory and, based at least in part on information stored in the at least one memory, the at least one processor, individually or in any combination, is configured to cause the network entity to:
partition a frequency range into a set of physical resource block groups (PRGs), wherein each PRG of the set of PRGs includes a number of resource blocks (RBs), and the number of RBs is greater than or equal to one;
assign the RBs in one or more PRGs of the set of PRGs respectively to multiple user equipment (UEs), wherein the RBs corresponding to a first UE of the multiple UEs occupy varied RB indices across the one or more PRGs; and
transmit, to the first UE, a downlink transmission using the RBs corresponding to the first UE.

9. The apparatus of claim 8, further comprising a transceiver coupled to the at least one processor, wherein to transmit the downlink transmission, the at least one processor, individually or in any combination, is configured to cause the network entity to transmit the downlink transmission via the transceiver, and wherein the at least one processor, individually or in any combination, is further configured to cause the network entity to:
transmit, to the first UE, a demodulation reference signal (DMRS) using the RBs corresponding to the first UE.

10. The apparatus of claim 9, wherein the at least one processor, individually or in any combination, is further configured to cause the network entity to:
transmit, to a second UE of the multiple UEs, the DMRS using the RBs corresponding to the second UE.

11. The apparatus of claim 9, wherein to assign the RBs in the one or more PRGs of the set of PRGs respectively to the multiple UEs, the at least one processor, individually or in any combination, is configured to cause the network entity to:
assign, based on an interleaver, the RBs in the one or more PRGs of the set of PRGs respectively to the multiple UEs, wherein a width of the interleaver is coprime with the number of the RBs.

12. The apparatus of claim 11, wherein the width of the interleaver is based on a total number of RBs in the frequency range and a depth of the interleaver.

13. The apparatus of claim 12, wherein the at least one processor, individually or in any combination, is further configured to cause the network entity to:
transmit, to the first UE, a configuration indicative of the depth of the interleaver.

14. The apparatus of claim 11, wherein the at least one processor, individually or in any combination, is further configured to cause the network entity to:
skip the downlink transmission in one PRG in the set of PRGs for the first UE.

15. The apparatus of claim 11, wherein the RBs in the one or more PRGs each have a row location and a column location based on the interleaver, and wherein the RB indices of the RBs corresponding to the first UE in the one or more PRGs are based on the column locations of the RBs.

16. The apparatus of claim 9, wherein to assign the RBs in the one or more PRGs respectively to the multiple UEs, the at least one processor, individually or in any combination, is configured to cause the network entity to:
assign, based on an interleaver and a set of index offsets for the set of PRGs, the RBs in each PRG of the one or more PRGs respectively to the multiple UEs, wherein a first index offset in the set of index offsets for a first PRG of the one or more PRGs is different from a second index offset in the set of index offsets for a second PRG of the one or more PRGs.

17. The apparatus of claim 16, wherein a width of the interleaver is coprime with the number of the RBs.

18. The apparatus of claim 16, wherein an RB index for the first UE in one PRG of the one or more PRGs is based on a modulo of the index offset for the one PRG to the number of RBs.

19. The apparatus of claim 9, wherein to assign the RBs in each PRG of the one or more PRGs respectively to the multiple UEs, the at least one processor, individually or in any combination, is configured to cause the network entity to:
assign, based on an interleaver and a set of index offsets for each PRG of the set of PRGs, the RBs in each PRG of the one or more PRGs respectively to the multiple UEs, wherein, for one PRG of the set of PRGs, a first index offset of the set of index offsets for a first symbol for physical downlink shared channel (PDSCH) is different from a second index offset of the set of index offsets for a second PDSCH symbol for the PDSCH.

20. A method of wireless communication at a network entity, comprising:
partitioning a frequency range into a set of physical resource block groups (PRGs), wherein each PRG of the set of PRGs includes a number of resource blocks (RBs), and the number of RBs is greater than or equal to one;
assigning the RBs in one or more PRGs of the set of PRGs respectively to multiple user equipment (UEs), wherein the RBs corresponding to a first UE of the multiple UEs occupy varied RB indices across the one or more PRGs; and
transmitting, to the first UE, a downlink transmission using the RBs corresponding to the first UE.
